(19) United States
(12) Patent Application Publication
(10) Pub. No.: US 2013/0154933 A1
(43) Pub. Date: Jun. 20, 2013

(54) FORCE TOUCH MOUSE

(71) Applicant: SYNAPTICS INCORPORATED, Santa Clara, CA (US)

(72) Inventor: Mohamed Ashraf Sheik-Nainar, Cupertino, CA (US)

(73) Assignee: SYNAPTICS INCORPORATED, Santa Clara, CA (US)

(21) Appl. No.: 13/719,502

(22) Filed: Dec. 19, 2012

Related U.S. Application Data
(60) Provisional application No. 61/578,081, filed on Dec. 20, 2011.

(51) Int. Cl. G06F 3/0354

(52) U.S. Cl. CPC G06F 3/03543
USPC 345/163

(57) ABSTRACT

Methods, systems and devices are described for operating an electronic device with a mouse, wherein the mouse includes a mouse movement sensor, a force sensor, and an input object position sensor. Operation of the mouse involves generating a first signal representing movement of the mouse relative to a working surface, generating a second signal representing force manually applied to the mouse, generating a third signal based on an input object in a sensing region of the mouse, and processing the first, second, and third signals to determine an interface action represented on a display of the electronic device.

### PRIORITY INFORMATION

This application claims priority to U.S. Provisional Patent Application Ser. No. 61/578,081, filed Dec. 20, 2011.

### FIELD OF THE INVENTION

This invention generally relates to electronic devices, and more specifically relates to sensor devices and using sensor devices for producing user interface inputs.

### BACKGROUND OF THE INVENTION

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

The proximity sensor device can be used to enable control of an associated electronic system. For example, proximity sensor devices are often used as input devices for larger computing systems, including: notebook computers and desktop computers. Proximity sensor devices are also often used in smaller systems, including: handheld systems such as personal digital assistants (PDAs), remote controls, and communication systems such as wireless telephones and text messaging systems. Increasingly, proximity sensor devices are used in media systems, such as CD, DVD, MP3, video or other media recorders or players. The proximity sensor device can be integral or peripheral to the computing system with which it interacts.

Some input devices, for example a mouse used to control an electronic device such as a host computer, also have the ability to detect applied force in addition to determining positional information for input objects interacting with a sensing region of the mouse. However, in presently known input devices, the ability to determine positional and force information is independent from (not integrated with) the movement of the mouse over a work surface. Thus, such input devices typically require the mouse to be held stationary when performing gestures to avoid inadvertent cursor movement. Moreover, the force component employed by presently known input devices is typically binary; that is, force is applied to the entire chassis and released to perform a mouse click. These factors limit the flexibility and usability of presently known force enabled mice. Thus, there exists a need for a mouse that enhances device flexibility and usability by combining force, positional information, and mouse movement to define a wide variety of interface actions and gestures while preserving the traditional cursor movement mode of use.

### BRIEF SUMMARY OF THE INVENTION

The embodiments of the present invention provide a device and method that facilitates improved device usability. Specifically, the device and method provide improved user interface functionality by facilitating user input with input objects using both force and positional information. The input device (mouse) includes a processing system and a plurality of sensors to detect the presence of fingers, force applied to the mouse, and mouse movement. The input device is adapted to provide enhanced user interface functionality by combining force sensing with a touch sensitive surface. In this way the level of applied force, in combination with finger positional information (including finger movement), may be combined with mouse movement to create a wide variety of input gestures.

According to various embodiments, an input device is capable of detecting multiple levels of force, and performing various functions (e.g., pointing, gestures,) by using the force information along with finger positional information and mouse movement to distinguish user inputs. The resulting force information, particularly when combined with the positional information of one or more fingers, palm, etc., in combination with mouse movement may be used to provide a wide range of user interface functionality and flexibility.

In one embodiment, the input device includes a single force sensor configured to sense total force applied to the device chassis. In other embodiments, multiple force sensors may be used to detect per finger force.

In one embodiment, there is a first force threshold for a light press, and a second force threshold for a heavy press. A light press followed by release will generate a first action (such as a traditional finger click). A heavy press, coupled with the presence of one or more fingers and/or coupled with mouse movement relative to a working surface, may generate more complex interactions such as gestures. The number of possible gestures may be based on, inter alia, the number of force levels that can be distinguished by the input device, the ability of the user to reliably apply a desired amount of force, the presence of one or more fingers or the palm of the user's hand on the sensing region, and mouse movement.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary electronic system that includes an input device and a processing system in accordance with an embodiment of the invention;

FIG. 2 is schematic top view of a force touch mouse in accordance with an embodiment of the invention;

FIG. 3 is a schematic view of an exemplary processing system in accordance with an embodiment of the invention;

FIG. 4 is a force level mapping diagram in accordance with an embodiment of the invention; and

FIG. 5 is a flow chart of a method of operating an electronic device with a force touch mouse in accordance with an embodiment of the invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention provide input devices and methods that facilitate improved usability. User interface functionality may be enhanced by integrating a force sensor (or multiple force sensors) into the mouse chassis to create a new interaction model in which gestures may be performed and disambiguated using mouse movement in conjunction with force and positional information. This permits the gestures to exploit the unbounded nature of mouse movement over a work surface.

Various embodiments involve replacing the traditional snap dome with a force sensor, allowing multiple levels of force to be employed in performing a wide variety of gestures and enhanced functions. For example, a first force range allocated to account for a user resting a finger on the mouse, a second force range for a light press, and a third force range for a heavy press (and which may include hysteresis effects). Light press and release performs a basic clicking action, whereas a heavy press with mouse movement is used to perform gestures.

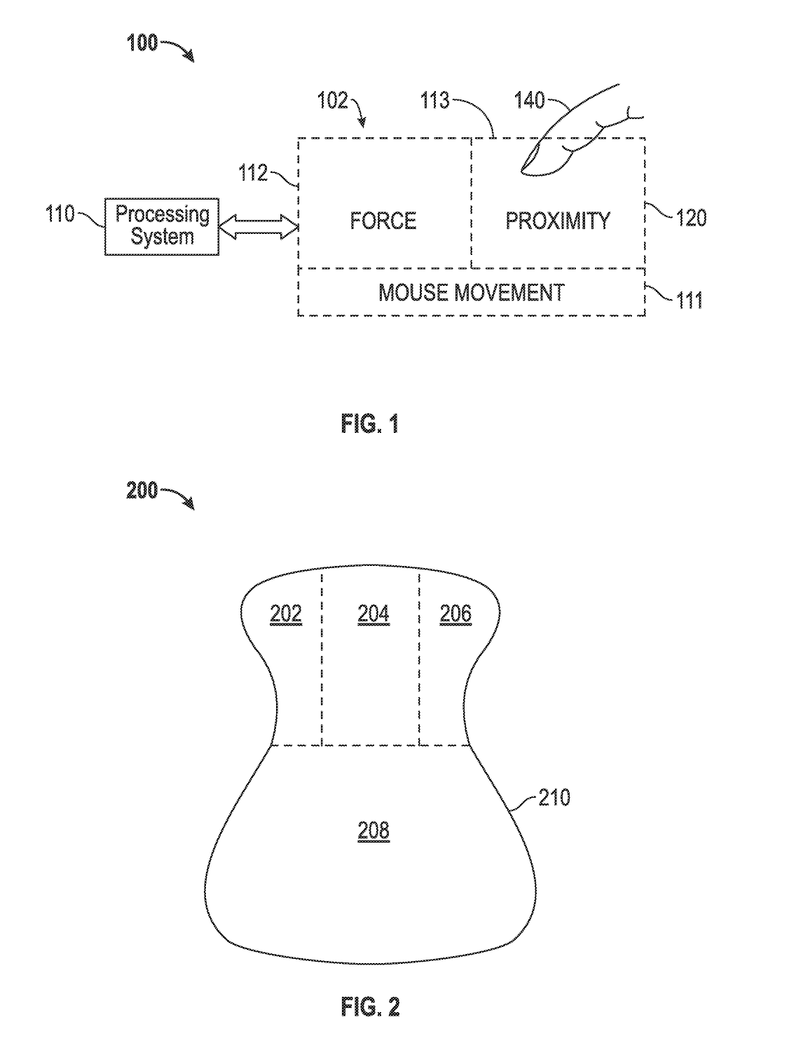

Turning now to the figures, FIG. 1 is a block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In a preferred embodiment, the input device 100 is a computer mouse having a processing system 110 and a sensing module 102. Sensing module comprises a sensing region 120 including a force sensor 112, a proximity sensor 113, and a motion (or mouse movement) sensor 111. The proximity sensor 113 (also often referred to as a “touchpad”) is configured to sense input provided by one or more input objects 140 (typically a human hand) in the sensing region 120. Example input objects include fingers, thumb, palm, and the entire hand. The sensing region 120 is illustrated schematically as a rectangle; however, it should be understood that the sensing region may be of any convenient form and in any desired arrangement on the surface of or otherwise integrated within the mouse chassis.

FIG. 1 illustrates an input device configured for proximity sensing, force sensing, and movement of the mouse across a work surface. In some embodiments, the input device is further configured to provide a haptic response to a user of the input device. The input device uses the proximity sensor, the force sensor(s), and the motion sensor to provide an interface for an electronic device or system.

Sensing region 120 includes sensors for detecting force, proximity, and mouse movement relative to a working surface, as described in greater detail below in conjunction with FIG. 2. Sensing region 120 may encompass any space above (e.g., hovering), around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device is adapted to provide user interface functionality by facilitating data entry responsive to the position of sensed objects and the force applied by such objects. Specifically, the processing system is configured to determine positional information for objects sensed by a sensor in the sensing region. This positional information can then be used by the system to provide a wide range of user interface functionality. Furthermore, the processing system is configured to determine force information for objects from measures of force determined by the force sensor(s). This force information can then also be used by the system to provide a wide range of user interface functionality. For example, by providing different user interface functions in response to different levels of applied force by objects in the sensing region. Furthermore, the processing system is configured to determine input information for object sensed in the sensing region. Input information can be based upon a combination the force information, the positional information, the number of input objects in the sensing region and/or in contact with the input surface, and a duration the one or more input objects is touching or in proximity to the input surface. Input information can then be used by the system to provide a wide range of user interface functionality.

The input device is sensitive to input by one or more input objects (e.g. fingers, styli, etc.), such as the position of an input object within the sensing region. The sensing region encompasses any space above, around, in and/or near the input device in which the input device is able to detect user input (e.g., user input provided by one or more input objects). The sizes, shapes, and locations of particular sensing regions may vary widely from embodiment to embodiment. In some embodiments, the sensing region extends from a surface of the input device in one or more directions into space until signal-to-noise ratios prevent sufficiently accurate object detection. The distance to which this sensing region extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device, contact with an input surface (e.g. a touch surface) of the input device, contact with an input surface of the input device coupled with some amount of applied force, and/or a combination thereof. In various embodiments, input surfaces may be provided by surfaces of casings within which the sensor electrodes reside, by face sheets applied over the sensor electrodes or any casings.

The electronic system 100 may utilize any combination of sensor components and sensing technologies to detect user input (e.g., force, proximity, and mouse movement) in the sensing region 120 or otherwise associated with the mouse. The input device 102 comprises one or more sensing elements for detecting user input. As several non-limiting examples, the input device 100 may use capacitive, elastive, resistive, inductive, magnetic, acoustic, ultrasonic, and/or optical techniques.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

It should also be understood that the input device may be implemented with a variety of different methods to determine force imparted onto the input surface of the input device. For example, the input device may include mechanisms disposed proximate the input surface and configured to provide an electrical signal representative of an absolute or a change in force applied onto the input surface. In some embodiments, the input device may be configured to determine force information based on a defection of the input surface relative to a conductor (e.g. a display screen underlying the input surface). In some embodiments, the input surface may be configured to deflect about one or multiple axis. In some embodiments, the input surface may be configured to deflect in a substantially uniform or non-uniform manner. In various embodiments, the force sensors may be based on changes in capacitance and/or changes in resistance.

In FIG. 1, a processing system 110 is shown as part of the input device 100. However, in other embodiments the processing system may be located in the host electronic device with which the mouse operates. The processing system 110 is configured to operate the hardware of the input device 100 to detect various inputs from the sensing region 120. The processing system 110 comprises parts of or all of one or more integrated circuits (ICs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions. The types of actions may include, but are not limited to, pointing, tapping, selecting, clicking, double clicking, panning, zooming, and scrolling. Other examples of possible actions include an initiation and/or rate or speed of an action, such as a click, scroll, zoom, or pan.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information, particularly regarding the presence of an input object in the sensing region. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

Likewise, the term “force information” as used herein is intended to broadly encompass force information regardless of format. For example, the force information can be provided for each input object as a vector or scalar quantity. As another example, the force information can be provided as an indication that determined force has or has not crossed a threshold amount. As other examples, the force information can also include time history components used for gesture recognition. As will be described in greater detail below, positional information and force information from the processing systems may be used to facilitate a full range of interface inputs, including use of the proximity sensor device as a pointing device for selection, cursor control, scrolling, and other functions.

Likewise, the term “input information” as used herein is intended to broadly encompass temporal, positional and force information regardless of format, for any number of input objects. In some embodiments, input information may be determined for individual input objects. In other embodiments, input information comprises the number of input objects interacting with the input device.

In some embodiments, the input device 100 is implemented with additional input components that are operated by the processing system 110 or by some other processing system. These additional input components may provide redundant functionality for input in the sensing region 120, or some other functionality. For example, buttons (not shown) may be placed near the sensing region 120 and used to facilitate selection of items using the input device 102. Other types of additional input components include sliders, balls, wheels, switches, and the like. Conversely, in some embodiments, the input device 100 may be implemented with no other input components.

In some embodiments, the electronic system 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

It should also be understood that the input device may be implemented with a variety of different methods to determine force imparted onto the input surface of the input device. For example, the input device may include mechanisms disposed proximate the input surface and configured to provide an electrical signal representative of an absolute or a change in force applied onto the input surface. In some embodiments, the input device may be configured to determine force information based on a defection of the input surface relative to a conductor (e.g. a display screen underlying the input surface). In some embodiments, the input surface may be configured to deflect about one or multiple axis. In some embodiments, the input surface may be configured to deflect in a substantially uniform or non-uniform manner.

As described above, in some embodiments some part of the electronic system processes information received from the processing system to determine input information and to act on user input, such as to facilitate a full range of actions. It should be appreciated that some uniquely input information may result in the same or different action. For example, in some embodiments, input information for an input object comprising, a force value F, a location X,Y and a time of contact T may result in a first action. While input information for an input object comprising a force value F′, a location X′,Y′ and a time of contact T′ (where the prime values are uniquely different from the non-prime values) may also result in the first action. Furthermore, input information for an input object comprising a force value F, a location X′,Y and a time of contact T′ may result in a first action. While the examples below describe actions which may be performed based on input information comprising a specific range of values for force, position and the like, it should be appreciated that that different input information (as described above) may result in the same action. Furthermore, the same type of user input may provide different functionality based on a component of the input information. For example, different values of F, X/Y and T may result in the same type of action (e.g. panning, zooming, etc.), that type of action may behave differently based upon said values or other values (e.g. zooming faster, panning slower, and the like).

As noted above, the embodiments of the invention can be implemented with a variety of different types and arrangements of capacitive sensor electrodes for detecting force and/or positional information. To name several examples, the input device can be implemented with electrode arrays that are formed on multiple substrate layers, typically with the electrodes for sensing in one direction (e.g., the “X” direction) formed on a first layer, while the electrodes for sensing in a second direction (e.g., the “Y” direction are formed on a second layer. In other embodiments, the sensor electrodes for both the X and Y sensing can be formed on the same layer. In yet other embodiments, the sensor electrodes can be arranged for sensing in only one direction, e.g., in either the X or the Y direction. In still another embodiment, the sensor electrodes can be arranged to provide positional information in polar coordinates, such as “Γ” and “θ” as one example. In these embodiments the sensor electrodes themselves are commonly arranged in a circle or other looped shape to provide “θ”, with the shapes of individual sensor electrodes used to provide “r”.

Also, a variety of different sensor electrode shapes can be used, including electrodes shaped as thin lines, rectangles, diamonds, wedge, etc. Finally, a variety of conductive materials and fabrication techniques can be used to form the sensor electrodes. As one example, the sensor electrodes are formed by the deposition and etching of conductive ink on a substrate.

In one embodiment, mouse movement may be detected using an infrared sensor configured to report movement relative to a working surface. Most commonly, such devices are used to provide input to control a cursor on a display.

In some embodiments, the input device is comprises a sensor device configured to detect contact area and location of a user holding the device. The input sensor device may be further configured to detect positional information about the user, such as the position and movement of the hand and any fingers relative to an input surface (or sensing region) of the sensor device.

In various embodiments, the mouse comprises a single actuation mechanism and a force sensor configured to provide force information relating to the actuation. A single button or the casing of the mouse may move relative to the chassis, actuating a switch which corresponds to an electronic signal processed by the processing system as an input action. In other embodiments, the mouse comprises multiple actuation mechanisms, analogous to left and right buttons on a conventional pointing device.

Input information from the mouse may comprise force information, motion information corresponding to mouse movement, and positional information corresponding to the hand and/or any fingers relative to the sensing region of the mouse.

In one embodiment, force information comprises a first force range allocated to account for user resting the finger on the mouse, a second force range for a light press and a third force range for a heavy press. A scenario where a user performs a light press and release may correspond to first action, while a heavy press along with substantial change in the positional information of the mouse may correspond to a second action. A third type of action may correspond to a light press and release when 2 fingers are in contact with the input surface, while a fourth type of action may correspond a single finger in the first force range which moves in a substantially horizontal or vertical direction.

Table 1 shown one exemplary embodiment where input information comprising the number of inputs objects interacting with the touch surface of the “mouse”, a force level imparted on the input device by the user, movement (or lack thereof) of the input objects relative to the input surface and movement (or lack thereof) of the mouse relative to a working surface is used to determine a plurality of actions. In one embodiment, as shown in Table 1, the plurality of actions comprises panning, scrolling, left, right and middle click, chiral (circular) scrolling, showing the desktop, forward/backward commands, copy, edge swipe, application selection, and the like.

In the following table, force level 0 refers to the force range allocated to account for user resting the finger on the mouse, force level 1 refers to the force range for light press and force level 2 refer to the force range for heavy press. Once a gesture is initiated with mouse movement, the finger force can be relaxed (or reduced) and the gesture can be terminated if the finger force reaches level 0, or a change in finger count, or lifted from the working surface.

TABLE 1
A comparison of possible actions with force information and
positional information

| | # | Force | Finger | Mouse |
|---|---|---|---|---|
| Gesture | Fingers | level | movement | movement |
| Pointing | 0+ | 0 | None | X, Y direction |
| Pan/Scroll | 1 | 0 | X, Y-direction | None |
| Zoom | 2 | 0 | Y-direction | None |
| Left click | 2 | 1 | None | None |
| Right click | 1 | 1 | None | None |
| Middle click | 3 | 1 | None | None |
| Left drag | 2 | 1 | None | X, Y direction |
| Right drag | 1 | 1 | None | X, Y direction |
| Copy/Paste | 1 | 2 | None | Y direction |
| Left/Right Edge Swipe | 1 | 2 | None | X direction |
| Chiral Scroll - vertical | 2 | 2 | None | Y-direction |
| Chiral Scroll - | 2 | 2 | None | X-direction |
| horizontal | | | | |
| Show/Clear desktop | 3 | 2 | None | Y-direction |
| Forward/Backward | 3 | 2 | None | X-direction |

In some embodiments, after initiating an action which requires a non-zero force level, the action may continue to be performed even if the user reduces the amount of force imparted on the mouse. In another embodiment, an action may cease to be performed if the number of input objects changes and/or the force imparted on the input device is reduced or reaches zero (or a “resting” force level) or lifted from the working surface. In another embodiment, an action may be modified in response to a change in the force information, positional information of the user and/or the mouse, or a change in the number of input objects. For example, a rate of zooming or scrolling may change based on a change in the force applied or the positional information corresponding to the mouse or the input objects.

In some embodiments, the input device comprises multiple actuation mechanisms and is capable of determining forces for some of the actuation mechanisms independently. Force information corresponding to the individual actuation mechanisms can be used along with other input information to generate appropriate actions. For example, in reference to the example of Table 1, left and right click actions may be initiated with the same number of input objects, based on the force information of each input.

In one embodiment, a pointing action is based on only positional information, while a primary (e.g. left-click) selection is performed in response to force information above a threshold for a single input object. Likewise, a secondary selection action (e.g. right click, middle click) is performed in response to force information above a threshold for two input objects. In one embodiment, primary or secondary selection is performed in two stages, similar to a real physical button. The first stage comprises force information meeting a first force threshold, indicating a “button down” event. The second stage comprises force information meeting a second force threshold indicating a “button up” event. Specifically, force information for the input object(s) increases above the first threshold subsequently decreases below the second threshold.

In another embodiment, a dragging action is performed in response to force information for an input object meeting a first threshold while positional information for the input object is relatively static, after which positional information is used to drag an object. The force information may need to remain above the threshold or may be reduced while the dragging action is performed. In one embodiment, the positional information for the input object may remain substantially static, while the positional information of a second input object is used to perform the dragging action.

In various embodiments, the processing system is configured to provide user feedback when a force threshold is met. Examples of user feedback may include auditory, haptic or visual. Furthermore, the various force thresholds for each action may be dynamically set by the user for a customized experience.

In another embodiment, a primary selection action can be further enhanced with a second force level threshold. Force information from an input object indicating force to have increased and then decreased past a first threshold will still correspond to the primary action (e.g. left-click). Additionally, force information from an input object indicating force to have increased and then decreased past a second, greater threshold may enable a different action, such as a right click, double click, select all or select more. FIG. 4 (discussed in greater detail below) illustrates two force thresholds and two force inputs. As can be seen one force input satisfies one force threshold while the other force input satisfies both force thresholds.

In one embodiment, the second force threshold can be used to extend gestures by mapping a range of force to control a parameter such as speed. For example, when a user performs an action such as a scroll, rotate, or zoom, the amount of force applied can modulate the speed of the scroll, zoom, or rotate. Applying additional force could continue the action after the user has run out of space on the input surface. This means that users will not have to reinitiate action, and gives more flexibility for the speed of the action.

In one embodiment, the combination of fingers and force applied can put the input device in a mode where the path/trajectory of the device can be used to activate widgets. For example, with a predefined number of fingers and force above force level 2, I the input device can be moved along the path of a backward “L” shape to activate a marking menu. Different widgets or menus can be activated by tracing different shapes/paths. In another embodiment, the tracing along predefined paths/shapes can be used as a shortcut for various interface actions such as launching an application.

It should be understood, that multiple force level thresholds may be used to provide advanced functionality. Furthermore, when there are multiple input objects interacting with the touch surface, the total or individual amount of force for the multiple objects may be used to control action parameters. That is, for a force sensor comprising multiple force sensing sub-regions, force may be detected and processed on a per finger basis.

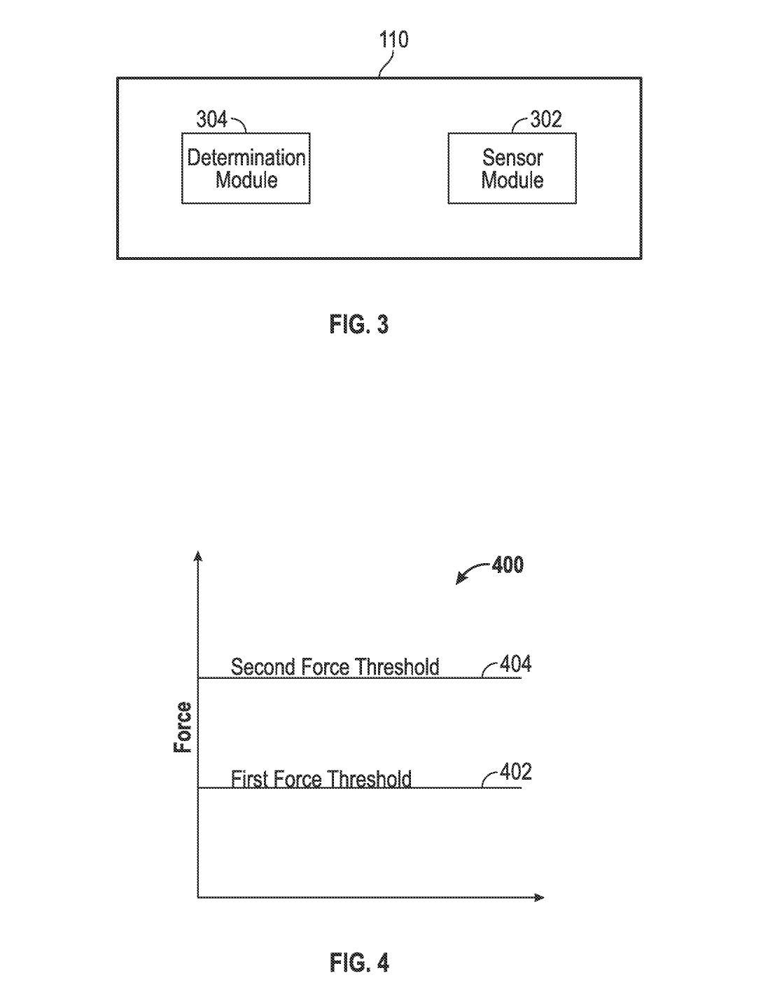

Referring now to FIGS. 1 and 3, the processing system 110 includes a sensor module 302 and a determination module 304. Sensor module 302 is configured to receive resulting signals from the sensors associated with sensing region 120. Determination module 304 is configured to process the data, and to determine positional information, the force information, and mouse movement information. The embodiments of the invention can be used to enable a variety of different capabilities on the host device. Specifically, it can be used to enable the cursor positioning, scrolling, dragging, and icon selection, Windows™ 8 edge swipe, putting a computer into sleep mode, or perform some other type of mode switch or interface action.

Referring now to FIG. 2, a force touch mouse 200 is shown having multiple force and/or proximity sensors to thereby enable the detection of per finger force in addition to detecting per finger presence. In particular, mouse 200 includes a first sub-region 202, a second sub-region 204, and a third sub-region 206 for finger placement, as well as a palm region 208. Using per finger force, left and right button clicks can be performed with both fingers on the mouse. Per finger (or sub-region) force can also be used to enhance gesture performance.

Referring now to FIG. 4, a force plot 400 illustrates a first force threshold value 402 and a second force threshold value 404, although additional values (levels) may also be implemented in the context of the present invention. These various force thresholds may be applied to a single force sensing region or to multiple force sensing sub-regions.

With continued reference to FIG. 4, an exemplary force level mapping (FIG. 4) may correspond to force applied in any one (or more) of the sub-regions 202-208. The force level mapping comprises one or more force levels indicating the amount of force applied to the mouse, which may be configured to detect a large number of force levels, only a few force levels, or one force level. The force levels may be segmented by force thresholds which establish boundaries (e.g., upper, lower, or both) between force ranges. Force ranges may be associated with various functions, (i.e., first action, second action, third action, etc.) such that it is possible for the user to activate a given function by applying a given force to a given region on the mouse surface. The number of force ranges and values of force thresholds may be based on the number of force levels that can be distinguished by the input device, the number of functions to be performed, and the ability of the user to reliably apply a desired amount of force on the input device, among other factors. While FIG. 4 illustrates a first and second force threshold, in other embodiments, more than two force thresholds may be used. Note also that first force threshold 402 corresponds to force level 1 in Table 1, and second force threshold 404 corresponds to force level 2 in Table 1.

For example, force information corresponding to an applied force that is greater than and/or equal to the first force threshold and less than and/or equal to the second force threshold may be indicative of a first action. Force information corresponding to an applied force that is greater than the first force threshold and greater than and/or equal to the second force threshold is indicative of a second action.

In an embodiment, images or icons can be displayed on the input device and the input device can perform functions associated with the images or icons. In various embodiments, the action (or function) corresponding to each image or icon corresponds to positional information and force information on the input device. For example, an action corresponding to a first image or icon may correspond to a first sub-region and the second force level. In such an example, the action is indicated based on positional information and force information corresponding to an input object. In an embodiment, images or icons may comprise buttons. By correlating the locations of the sub-regions of various buttons with the location of the input, it is possible to determine which button was pressed. In one embodiment, a function corresponding to an image or icon may be performed based at least on the positional information and force information of at least one input object.

The above examples are intended to illustrate several of the functions that could be performed for various degrees, levels, thresholds, or ranges of force. Other functions that could be performed for a given level of force include, but are not limited to, scrolling, clicking (such as double, triple, middle, and right mouse button clicking), changing window sizes (such as minimizing, maximizing, or showing the desktop), and changing parameter values (such as volume, playback speed, brightness, z-depth, and zoom level).

It is also possible to adjust the sensitivity of the input device by changing the force thresholds. These configurations can be performed manually by the user via software settings. Alternatively, or in addition to, various touch algorithms can automatically adjust one or more force thresholds (e.g., based on historical usage data).

In various embodiments, visual, audible, haptic, or other feedback may be provided to the user to indicate the amount of force has been applied. For example, a light can be illuminated or an icon displayed to show the amount of force applied to the input device. Alternatively, or in addition to, a cue, such as an icon of the layout, can be displayed on screen. Similarly, audible feedback may be provided either through an audio sub-system as part of the input device or as part of the interacting device (computer) to indicate when applied force reaches a defined level.

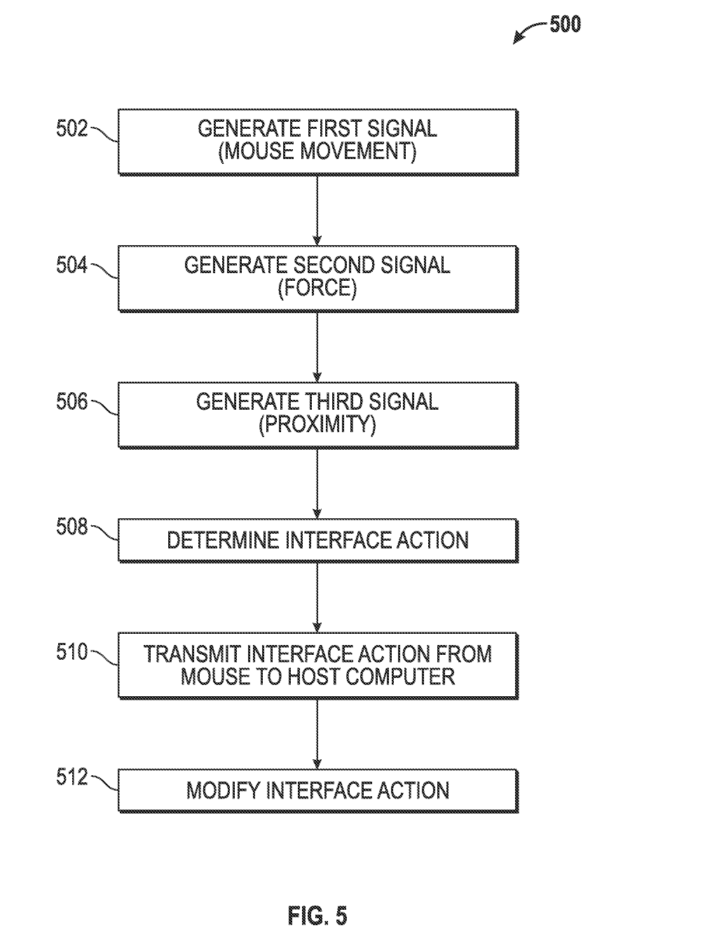

FIG. 5 is a flow chart illustrating a method 500 of operating an electronic device with a force touch mouse of the type which includes a mouse movement sensor, a force sensor, and an input object position sensor (touch or proximity sensor). The method 500 includes generating (task 502) a first signal representing mouse movement, generating (task 504) a second signal representing applied force, and generating (task 506) a third signal representing one or more fingers (or a palm) interacting with the sensing region. The method 500 further includes processing (task 508) the first, second, and third signals to determine an interface action displayed on the electronic device.

With continued reference to FIG. 5, the method 500 further includes transmitting (task 510) the interface action from the mouse to the host processor associated with the electronic device. The method 500 further involves modifying (task 512) the interface action based on a change in one or more of the signals.

An input module for use with an electronic device is thus provided which includes a first sensor configured to detect movement of the module and generate a first signal, a second sensor configured to detect force applied to the module and generate a second signal, and a third sensor configured to detect the presence of an input object in a sensing region of the module and generate a third signal. The first signal is used to position a cursor on a display associated with the electronic device, and the second and third signals are used to determine an interface action.

In an embodiment, the first sensor comprises a motion sensor configured to determine movement of the module relative to a working surface, the second sensor comprises a force sensor configured to determine force applied to a force transmitting surface of the input module, and the third sensor comprises a contact sensor configured to determine positional information of at least one input object in the sensing region.

In an embodiment, the interface action includes at least one of panning, scrolling, left click, right click, middle click, chiral scrolling, showing the desktop, forward command, backward command, copy, paste, edge swipe, and application selection.

In an embodiment, the input object comprises at least one of a finger, multiple fingers, and a palm, and the third sensor is configured to determine, and the third signal is configured to represent, the number and type of input objects in the sensing region.

In another embodiment, the second sensor is configured to: detect a first level of force when the input object is resting on the sensing region; detect a second level of force when the input object applies a light press to the sensing region; and detect a third level of force when the input object applies a heavy press to the sensing region.

In another embodiment, the input module is a mouse which includes a touch pad and a three dimensional chassis (the mouse body).

In an embodiment, the input module is configured to operate in a first mode in which the first signal is used to position the cursor on the display, and in a second mode wherein at least two of the first, second, and third signals are used to determine the interface action.

In another embodiment, the sensing region comprises first and second sub-regions, and the second sensor is configured to detect an input object on each of the first and second sub-regions and to determine corresponding respective force levels applied to the first and second surfaces.

In an embodiment, the interface action is determined based on the motion of one or more input objects, force applied by one or more input objects, and/or motion of the input module. Once an interface action is initiated it may be modified by one or a combination of the first, second and third signals. Moreover, the level of force required to initiate a particular interface action may be reduced while that interface action continues. An initiated interface action may be terminated by any one or combination of: reducing a force level; removing at least one input object from the sensing region; and lifting the input device from the working surface.

In an embodiment, an interface action initiated by at least two of the first, second, and third signals may be continued by using additional data from at least one of the first, second and third signals.

A method is also provided for operating an electronic device with a mouse of the type which includes a mouse movement sensor, a force sensor, and an input object position sensor. The method includes the steps of generating a first signal representing movement of the mouse relative to a working surface, generating a second signal representing force manually applied to the mouse, generating a third signal based on an input object in a sensing region of the mouse, and processing the first, second, and third signals to determine an interface action represented on a display associated with the electronic device. The method may further include transmitting the interface action from the mouse to the computer. In an embodiment the method, further involves modifying the interface action by changing one of the first, second, and third signals.

A processing system for use with a mouse is also provided, the processing system including a sensor module and a determination module. In an embodiment, the sensor module is configured to acquire a first signal corresponding to movement of the mouse relative to a working surface, a second signal corresponding to force applied by an input object to a transmitting surface of the mouse, and a third signal corresponding to positional information for an input object interacting with a sensing region of the mouse; and the determination module is configured to position a cursor on a display based on the first signal, and to determine an interface action based on the second and third signals. The determination of the interface action may be based on at least two of: the motion of one or more input objects; force applied by one or more input objects; and motion of the input module.

In an embodiment, the input object comprises at least one of a finger, multiple fingers, and a palm, and the third sensor is configured to determine, and the third signal is configured to represent, the number and type of input objects in the sensing region.

In another embodiment, the second signal comprises: a first level of force when the input object is resting on the sensing region; a second level of force when the input object applies a light press to the sensing region; and a third level of force when the input object applies a heavy press to the sensing region.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Other embodiments, uses, and advantages of the invention will be apparent to those skilled in art from the specification and the practice of the disclosed invention.

What is claimed is:

1. An input module for use with an electronic device, the input module comprising:
a first sensor configured to detect movement of the module and generate a first signal;
a second sensor configured to detect force applied to the module and generate a second signal; and
a third sensor configured to detect the presence of an input object in a sensing region of the module and generate a third signal;
wherein the first signal is used to position a cursor on a display associated with the electronic device, and the second and third signals are used to determine an interface action.

2. The input module of claim 1, wherein:
the first sensor comprises a motion sensor configured to determine movement of the module relative to a working surface;
the second sensor comprises a force sensor configured to determine force applied to a force transmitting surface of the input module; and
the third sensor comprises a contact sensor configured to determine positional information of at least one input object in the sensing region.

3. The input module of claim 1, wherein the interface action comprises at least one of panning, scrolling, left click, right click, middle click, chiral scrolling, showing the desktop, forward command, backward command, copy, paste, edge swipe, and application selection.

4. The input module of claim 1, wherein the input object comprises at least one of a finger, multiple fingers, and a palm, and further wherein the third sensor is configured to determine, and the third signal is configured to represent, the number and type of input objects in the sensing region.

5. The input module of claim 1, wherein the second sensor is configured to:
detect a first level of force when the input object is resting on the sensing region;
detect a second level of force when the input object applies a light press to the sensing region; and
detect a third level of force when the input object applies a heavy press to the sensing region.

6. The input module of claim 1, wherein the input module is a mouse and the mouse comprises a touch pad and a three dimensional chassis.

7. The input module of claim 1, wherein the input module is configured to operate in a first mode in which the first signal is used to position the cursor on the display, and in a second mode wherein at least two of the first, second, and third signals are used to determine the interface action.

8. The input module of claim 1, wherein the sensing region comprises a first touch surface and a second touch surface, and further wherein the second sensor is configured to detect an input object on each of the first and second touch surfaces and to determine corresponding respective force levels applied to the first and second surfaces.

9. The input module of claim 8, wherein the determination of the interface action is based on the motion of one or more input objects, force applied by one or more input objects, and motion of the input module.

10. The input module of claim 3, wherein an interface action initiated is modified by at least one of the first, second and third signals.

11. The input module of claim 3, wherein the level of force required to initiate a particular interface action may be reduced while that interface action continues.

12. The input module of claim 1, wherein an initiated interface action may be terminated by one of:
reducing a force level;
removing at least one input object from the sensing region; and
lifting the input device from the working surface.

13. The input module of claim 1, wherein an interface action initiated by at least two of the first, second, and third signals may be continued by using additional data from at least one of the first, second and third signals.

14. A method of operating an electronic device with a mouse, the mouse comprising a mouse movement sensor, a force sensor, and an input object position sensor, and the method comprising:
generating a first signal representing movement of the mouse relative to a working surface;
generating a second signal representing force manually applied to the mouse;
generating a third signal based on an input object in a sensing region of the mouse; and
processing the first, second, and third signals to determine an interface action represented on a display of the electronic device.

15. The method of claim 17, further comprising transmitting the interface action from the mouse to the computer.

16. The method of claim 17, further comprising modifying the interface action by changing one of the first, second, and third signals.

17. A processing system for use with a mouse, the processing system comprising:
a sensor module configured to acquire a first signal corresponding to movement of the mouse relative to a working surface, a second signal corresponding to force applied by an input object to a transmitting surface of the mouse, and a third signal corresponding to positional information for an input object interacting with a sensing region of the mouse; and
a determination module configured to position a cursor on a display based on the first signal, and to determine an interface action based on the second and third signals.

18. The processing system of claim 17, wherein the determination of the interface action is based on at least two of: the motion of one or more input objects; force applied by one or more input objects; and motion of the input module.

19. The processing system of claim 17, wherein the input object comprises at least one of a finger, multiple fingers, and a palm, and further wherein the third sensor is configured to determine, and the third signal is configured to represent, the number and type of input objects in the sensing region.

20. The processing system of claim 17, wherein the second signal comprises:
a first level of force when the input object is resting on the sensing region;
a second level of force when the input object applies a light press to the sensing region; and
a third level of force when the input object applies a heavy press to the sensing region.
